(19) United States
(12) Patent Application Publication
(10) Pub. No.: US 2002/0089488 A1
(43) Pub. Date: Jul. 11, 2002

(54) Apparatus and method for controlling a picture whithin a picture display device

(75) Inventors: Gerald F. McBrearty, Austin, TX (US); Shawn P. Mullen, Buda, TX (US); David W. Shaevel, Austin, TX (US); Johnny M. Shieh, Austin, TX (US); Guha P. Venkataraman, Austin, TX (US)

Correspondence Address: Edmond A. DeFrank, 20145 Via Medici, Northridge, CA, 91326, US

(73) Assignee: International Business Machines Corporation, Armonk, NY (US)

(21) Appl. No.: 09/758,732

(22) Filed: Jan. 11, 2001

(51) Int. Cl. G09G 5/08

(52) U.S. Cl. 345/157

(57) ABSTRACT

An apparatus and method for providing control of a picture within a picture display device having at least two windows that receive input from two different computers. The present invention permits a user to use input devices from one of these computers to control cursor movements in all windows. Moreover, the present invention allows data and images to be cut and pasted between the windows. The apparatus of the present invention includes a PWP control module that resides on each of the computers connected to the PWP display device. The PWP control device provides cursor control on the PWP display device and communicates cursor movements to the appropriate computer, depending on the cursor location. Moreover, the PWP control module includes a buffer for storing cut and paste data such that a common buffer is used to store cut and paste data from each computer. The method of the present invention includes using an input device connected to one of the computers to move the cursor, determining at which window the cursor is located, and sending a movement signal from the input device to the window at which the cursor is located.

### BACKGROUND OF THE INVENTION

1. Field of the Invention

The present invention relates in general to multi-input display devices and more particularly to an apparatus and method for providing control of a picture within a picture (PWP) display device having inputs from two different computers displayed in two separate windows such that an input device from one of the computers can be used to control both windows.

2. Related Art

Picture within a picture (PWP) display devices are popular devices that allow connection of at least two computers. PWP display devices are popular among higher-end computer systems for connecting to multiple command workstations. The PWP display device typically has two input ports with each port connected to a separate computer. The PWP display device is similar to a typical computer display device except that the PWP display device can display data from two computers simultaneously. The PWP display device displays data from a first computer in a first window (typically the main or background window) and data from a second computer in a second window (typically a smaller window). A cursor on the PWP display device is controlled by the first computer when the cursor is in the first window. This allows the user to control and manipulate the data displayed in the first window with a first input device (such as a mouse) connected to the first computer. When the cursor is moved to the border of the second window the first input device can no longer control the cursor and the cursor stops. The user must then move over to the second computer and use a second input device (such as a mouse) connected to the second computer to control the cursor. Thus, the mouse connected to the first computer is used to control the cursor when it is in the first window while the mouse connected to the second computer is used to control the cursor when it is in the second window.

There are several problems with this arrangement. First, whenever the cursor reaches the border of the second window it will no longer accept inputs from the mouse of the first computer. This means that the user must move to the second computer and use the mouse connected to the second computer to control the cursor. This takes time, is inconvenient and can cause user frustration. More importantly, it is not possible to cut or paste in or out of the second window. This is because all cut and paste data is stored in the mouse driver buffer area of each respective computer.

Accordingly, what is needed is an apparatus and method for controlling a PWP display device that eliminates the need for a user to manually move between the input devices of separate computers. In particular, what is needed is a PWP display device control apparatus and method that allow a single keyboard/mouse pair to be used to control both windows on the PWP display device. Moreover, what is needed is an apparatus and method that permits cutting and pasting between windows of the PWP display device.

### SUMMARY OF THE INVENTION

To overcome the limitations in the prior art as described above and other limitations that will become apparent upon reading and understanding the present specification, the present invention includes an apparatus and method for controlling a picture within a picture (PWP) display device. The PWP display device, which is connected to least two computers, contains a main window (that displays data and images from a first computer) and a PWP window (that displays data and images from a second computer). The present invention allows a user to use input devices from one of the computers to control data and images in both windows. The present invention also allows data and images to be cut and pasted between the main window and the PWP window.

The apparatus of the present invention includes a PWP control module that resides on each of the computers connected to the PWP display device. The PWP control device provides cursor control on the PWP display device and communicates cursor movements to the controlling computer. Moreover, the PWP control module includes a buffer for storing cut and paste data such that a central buffer is used to store cut and paste data from each computer. This enables the present invention to allow cutting and pasting between the main window and the PWP window. The method of the present invention includes providing a PWP display device and computers connected to the device and selecting a default input device. The method further includes determining which display area the cursor in located and using the PWP control module to communicate cursor movements to the corresponding computer. Moreover, the present invention includes storing cut and paste data in a common PWP control module buffer.

Other aspects and advantages of the present invention as well as a more complete understanding thereof will become apparent from the following detailed description, taken in conjunction with the accompanying drawings, illustrating by way of example the principles of the invention. Moreover, it is intended that the scope of the invention be limited by the claims and not by the preceding summary or the following detailed description.

### BRIEF DESCRIPTION OF THE DRAWINGS

The present invention can be further understood by reference to the following description and attached drawings that illustrate the preferred embodiments. Other features and advantages will be apparent from the following detailed description of the invention, taken in conjunction with the accompanying drawings, which illustrate, by way of example, the principles of the present invention.

Referring now to the drawings in which like reference numbers represent corresponding parts throughout:

FIG. 1 is a block diagram of a computer system incorporating the present invention and is shown for illustrative purposes only.

FIG. 2 is a block diagram illustrating the components of the present invention.

FIG. 3A is an exemplary example illustrating the control flow of the present invention when the cursor is in the main window.

FIG. 3B is an exemplary example illustrating the control flow of the present invention when the cursor is on the border of the PWP window.

FIG. 4 is a general flow diagram illustrating the operation of the PWP control module shown in FIG. 2.

### DETAILED DESCRIPTION OF THE INVENTION

In the following description of the invention, reference is made to the accompanying drawings, which form a part thereof, and in which is shown by way of illustration a specific example whereby the invention may be practiced. It is to be understood that other embodiments may be utilized and structural changes may be made without departing from the scope of the present invention.

I. Introduction

Current picture within a picture (PWP) display devices allow the connection of two or more computers and display information (such as data, text, video and images) from these computer in separate windows on the PWP display device. One way to control the information in each window is using a cursor on the PWP display device that can be moved within each window to manipulate and control information within the respective window. However, input devices from each computer can only be used to control each computer's respective window. In other words, which computer is controlling the cursor depends on which window the cursor is located. For example, if the cursor is located in the main window displaying data from a first computer the user controls the cursor using input devices from the first computer. Similarly, if the cursor is located in the PWP window displaying data from a second computer the user controls the cursor using input devices from the second computer. In order to change between input devices for the first and the second computers, the user must manually move between the two computers and associated input devices.

The present invention provides an apparatus and method for allowing the input devices of one of the computers connected to the PWP display device to control information displayed in both windows. By way of example, even if the user is controlling the information using a cursor with an input device connected to the first computer and the cursor is moved to the border of the PWP window, the user can use the first computer's input devices to control and manipulate information within the PWP window without moving to another computer. Moreover, the present invention allows data and images to be cut and paste between the main window and the PWP window of the PWP display device.

II. Exemplary Operating Environment

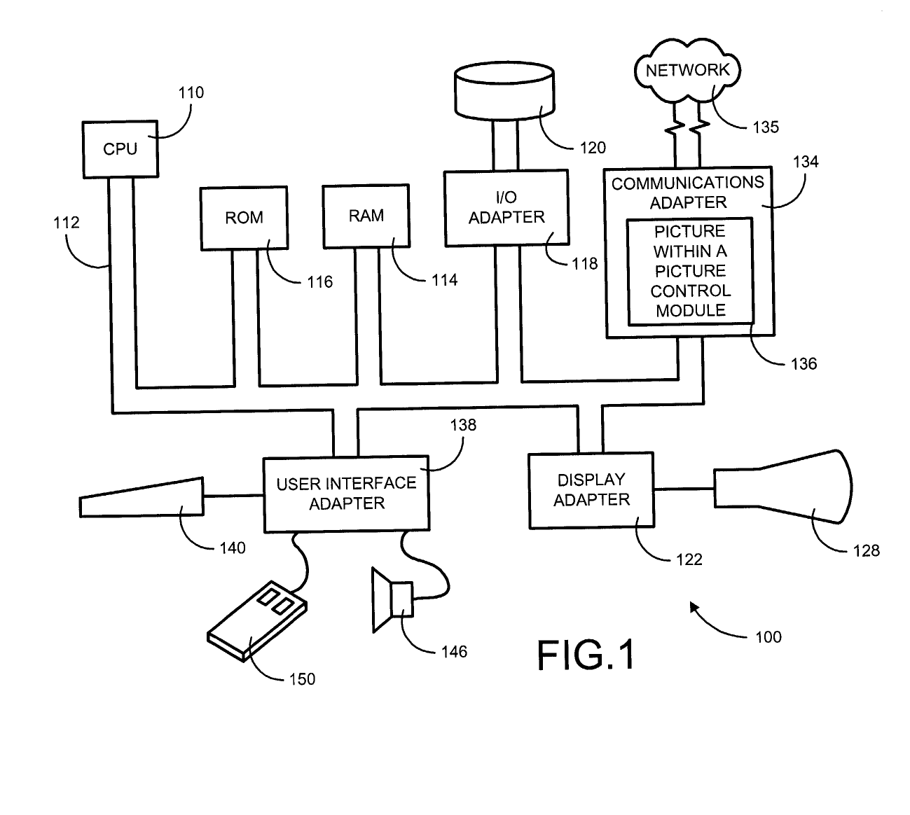

The following discussion is designed to provide a brief, general description of a suitable environment in which the present invention may be implemented. It should be noted that FIG. 1 depicts only one of several ways in which the present invention may be implemented.

FIG. 1 is a block diagram of a computer system incorporating the present invention and is shown for illustrative purposes only. In particular, a computer system 100 includes any suitable central processing unit (CPU) 110, such as a standard microprocessor, and any number of other objects interconnected by a computer bus 112. It should be noted that the computer system 100 may also include a plurality of CPUs 110, such as may be used in a mainframe computer. For purposes of illustration, the computer system 100 includes memory such as random-access memory (RAM) 114, read-only memory (ROM) 116, and storage devices (such as hard disk or disk drives 120) connected to the computer bus 112 by an input/output (I/O) adapter 118. The computer system 100 further includes a display adapter 122 for connecting the computer bus 112 to a suitable display device 128. A communications adapter 134 connects the computer bus 112 with a network 135. The communications adapter 134 includes a picture within a picture control module 136, which includes communications program for controlling a picture within a picture (PWP) display device in accordance with the present invention.

A user interface adapter 138 is capable of connecting the computer bus 112 to other user interface devices, such as a keyboard 140, a speaker 146, a mouse 150 and a touchpad (not shown). In a preferred embodiment, a graphical user interface (GUI) and an operating system (OS) reside within a computer-readable media and contain device drivers that allow one or more users to manipulate object icons and text on the display device 128. Any suitable computer-readable media may retain the GUI and OS, such as, for example, the RAM 114, ROM 116, hard disk or disk drives 120 (such as magnetic diskette, magnetic tape, CD-ROM, optical disk or other suitable storage media).

III. Components and Operation of the Invention

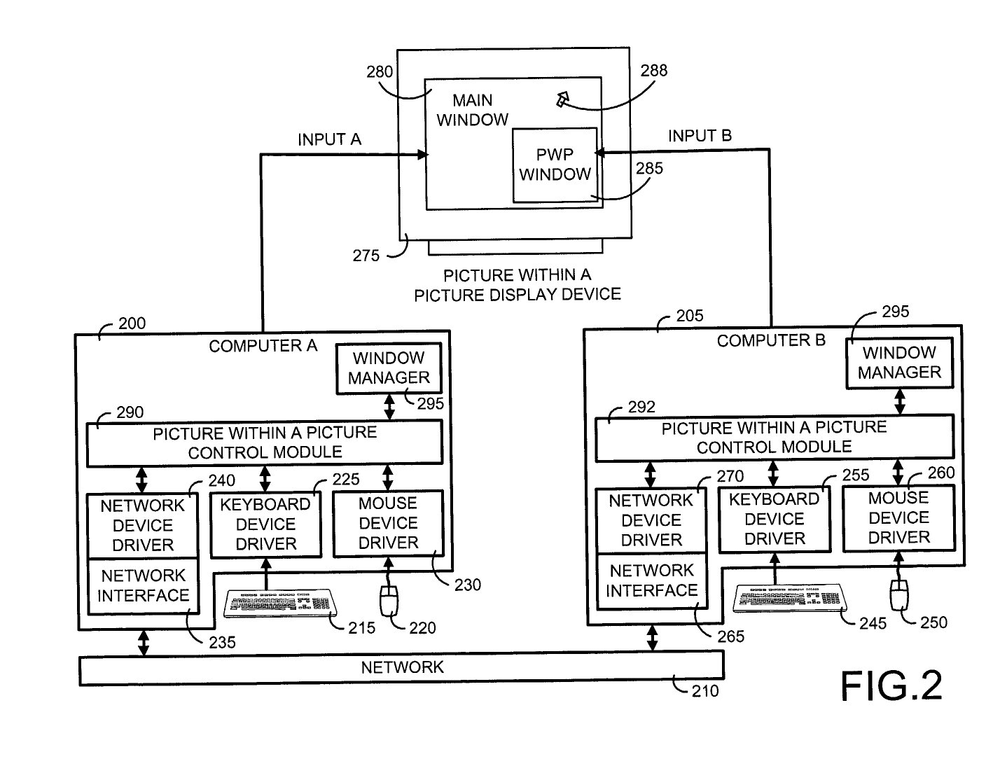

The apparatus of the present invention allows control of a picture within a picture (PWP) display device by providing a PWP control module on each computer connected to the PWP display device. FIG. 2 is a block diagram illustrating the components of the present invention. In general, the present invention includes a first computer (computer A 200) and a second computer (computer B 205), which are in communication over a network 210. Computer A 200 includes input devices such as keyboard A 215 and mouse A 220. Keyboard A 215 is in communication with a keyboard device driver 225 and mouse A 220 is in communication with a mouse device driver 230. A network interface 235 and a network device driver 240 allow communication between computer A 200 and the network 210. Similarly, computer B 205 includes input devices such as keyboard B 245 and mouse B 250 and a keyboard device driver 255 and a mouse device driver 260. These respective input devices for each computer provide interaction between a user and data on a display device. Moreover, mouse A 220 and mouse B 250 provide additional functions such a drag and drop capabilities used in cut and paste operations. These additional functions and operations are well known to those having ordinary skill in the art. Computer B 205 also includes a network interface 265 and a network device driver 270 for allowing communication between computer B 205 and the network 210.

A picture within a picture (PWP) display device 275 includes an input A (for connecting computer A 200 to the PWP display device 275) and an input B (for connecting computer B 205 to the PWP display device 275). The PWP display device includes a main window 280 (to which computer A 200 is connected) and a PWP window 283 (to which computer B 205 is connected). This gives the PWP display device 275 the capability to display data and images from computer A 200 in the main window 280 and to display data and images from computer B 205 in the PWP window 285. A cursor 288 is located on the PWP display device 275 and can be controlled by mouse A 220 or mouse B 250. In a preferred embodiment, mouse A 220 is all that is needed to control the cursor 288 in both the main window 280 and the PWP window 285. It should be noted that the picture within a picture concept can be implemented in several other ways, and FIG. 2 is merely an exemplary representation of the PWP concept.

Computer A 200 and computer B 205 also include a PWP control module on computer A 290 and a PWP control module on computer B 292 for allowing control of the PWP display device 275. The operation of the PWP control modules 290, 292 is explained in detail below. Both computer A 200 and computer B 205 also include a window manager 295 that notifies the PWP control modules 290, 292 on each computer the location of the cursor 288.

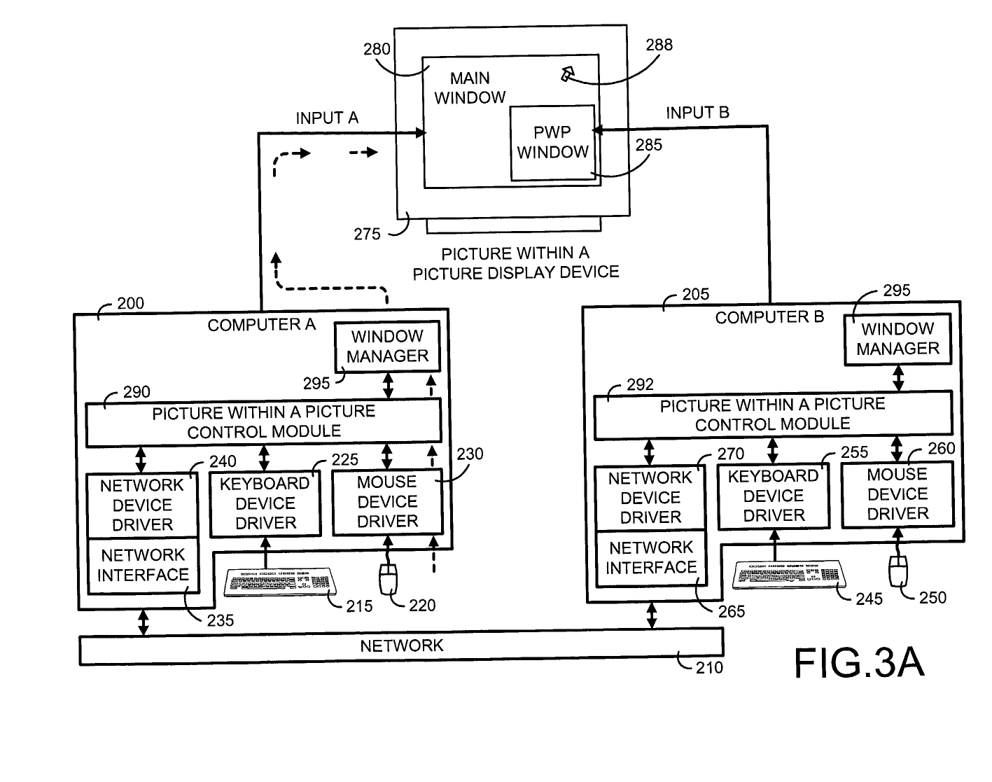

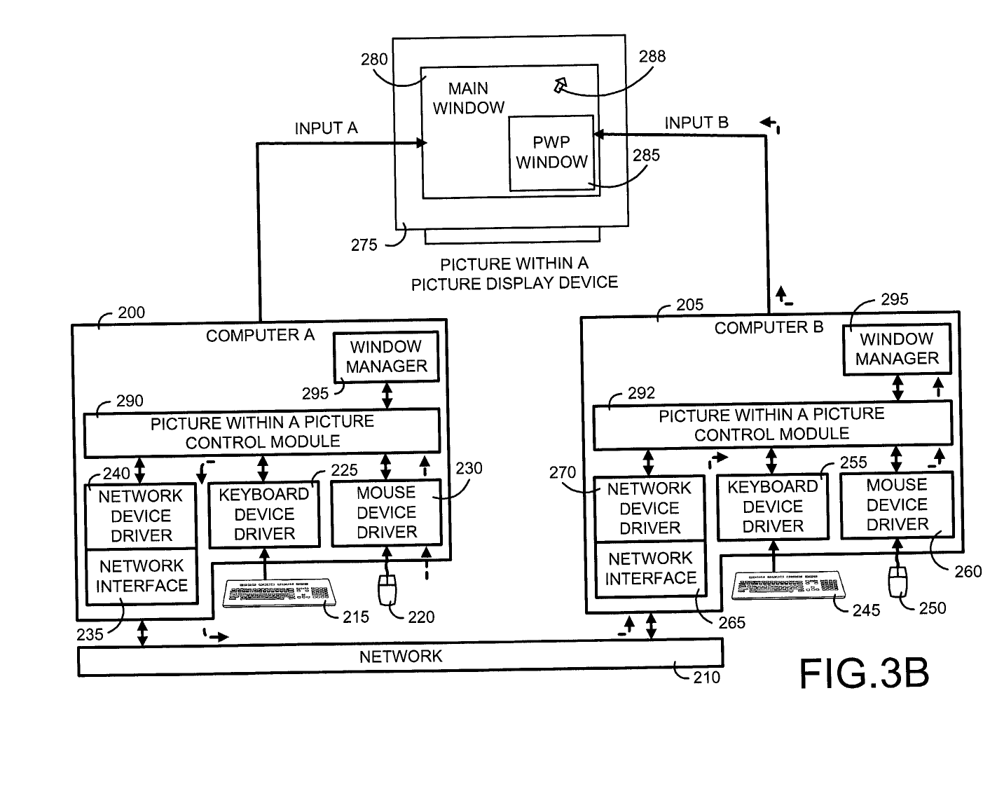

FIG. 3A is an exemplary example illustrating the control flow (as depicted by the dashed arrows) of the present invention when the cursor 288 is in the main window 280. In this example, the cursor 288 is controlled by mouse A 220. When a user moves mouse A 220, a signal to move the cursor (or a movement signal) is generated. The path of the movement signal from mouse A 220 to the cursor 288 located in the main window 280 is shown in FIG. 3A by the arrows. Specifically, the movement signal is sent from mouse A 220 through the mouse device driver 230 to the PWP control module on computer A 290. The PWP control module 290 knows to send the movement signal to input A because the window manager 295 on computer A 200 informs the PWP control module 290 that the cursor 288 is within the main window 280.

FIG. 3B is an exemplary example illustrating the control flow (as depicted by the dashed arrows) of the present invention when the cursor 288 is on the border of the PWP window 285. In this example, the present invention allows the cursor 288 to continue to be controlled by mouse A 220. When the user moves mouse A 220, a movement signal is generated. The path of the movement signal from mouse A 220 to the cursor 288 located at the border of or in the PWP window 285 is shown in FIG. 3B by the arrows. In particular, the movement signal passes from mouse A 220 through the mouse device driver 230 and to the PWP control module on computer A 290. At this point, the PWP control module 290 has been notified by the window manager 295 on computer A 200 that the cursor 288 is on the border the PWP window 285. Upon receiving this information, the PWP control module on computer A 290 redirects the movement signal received from mouse A 220 to the network device driver 240 and the network interface 235 where the movement signal is sent over the network 210 to computer B 205. The movement signal is received by the network interface 265 and network device driver 270 on computer B 205 and sent to the PWP control module on computer B 292. The PWP control module 292 recognizes that the movement signal needs to be sent to the PWP window 285 because the window manager 295 informed the PWP control module on computer B 292. The PWP control module 292 sends the movement signal from mouse A 220 through input B to the PWP window 285 where the cursor 288 is moved in response to the movement signal from mouse A 220.

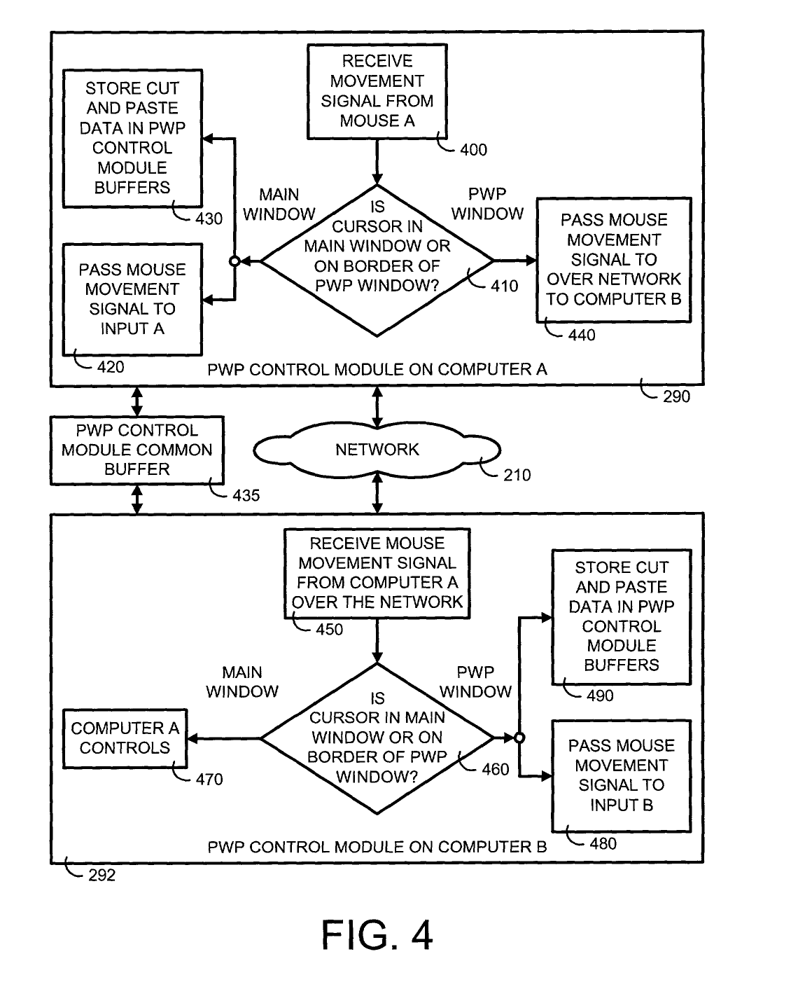

FIG. 4 is a general flow diagram illustrating the operation of the PWP control module shown in FIG. 2. Referring to FIGS. 3A, 3B and 4, the operation of the PWP control module will now be explained. This explanation assumes that mouse A is the input device used to control the cursor. The PWP control module on computer A 290 and the PWP control module on computer B 292 are in communication over the network 210. Referring to the PWP control module on computer A 290, a movement signal is received from mouse A (box 400). Based on information from the window manager, it is determined whether the cursor is in the main window or on the border of the PWP window (box 410). If the cursor is in the main window, the PWP control module 290 passes the movement signal received from mouse A to input A (box 420). In addition, if a cut and paste operation is being performed between windows, the cut and paste data is stored in a PWP control module common buffer 435. If the cursor is on the border of the PWP window, the movement signal from mouse A is sent over the network 210 to computer B (box 440).

Referring now to the PWP control module on computer B 292, the movement signal from mouse A is received over the network from computer A (box 450). The window manager determines whether the cursor is in the main window or on the border of the PWP window (box 460). If the cursor is in the main window, the PWP control module on computer B 292 does nothing because computer A has control of the cursor and all movement signals are sent to input A (box 470). If the cursor is on the border of the PWP window, the PWP control module on computer B 292 passes the movement signal to input B (box 480). In this manner, mouse A can be used to control the cursor within both the main window and the PWP window. If a cut and paste operation is being performed between windows, the cut and paste data is stored in the PWP control module common buffer 435.

The PWP control module common buffer 435 is a common mouse buffer storage area for consolidated buffering of cut and paste data. This enables data and images from the PWP window to be cut and pasted into the main window and vice versa. This is achieved using the PWP control module common buffer 435 to store cut and paste data instead of using the separate buffers for mouse A and mouse B.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description of the invention, but rather by the claims appended hereto.

What is claimed is:

1. A method for using an input device to control information displayed on a display device having a first window that displays information from a main computer and a second window that displays information from a remote computer, comprising:
controlling and manipulating information displayed in the first window using the input device and the main computer; and
controlling and manipulating information displayed in the second window using the input device and the remote computer;
wherein the input device is connected to the main computer.

2. The method of claim 1, wherein the input device controls a cursor on the display device to control and manipulate displayed information.

3. The method of claim 1, wherein the main computer and the remote computer are connected by a network.

4. The method of claim 1, wherein the display device is a picture within a picture display device and the first window is a main window and the second window is a picture within a picture window.

5. The method of claim 2, wherein the cursor is located in the second window and a movement signal from the input device is sent from the remote computer to the second window.

6. The method of claim 5, wherein sending the movement signal further comprises transmitting the movement signal over a network connecting the main computer and the remote computer.

7. The method of claim 2, wherein a user can use the input device to move the cursor between the first window and the second window.

8. The method of claim 7, wherein information displayed on the display device may be cut and pasted between the first window and the second window.

9. The method of claim 8, further comprising storing cut and paste data in a common memory buffer.

10. A method for controlling a cursor on a picture within a picture display device having a main window and a picture within a picture window, comprising:
connecting a first computer to the main window and a second computer to the picture within a picture window; and
using an input device connected to the first computer to move the cursor in both the main window and the picture within a picture window.

11. The method of claim 10, further comprising determining in which window the cursor is located.

12. The method of claim 11, further comprising sending a movement signal from the input device to the window where the cursor is located.

13. A picture within a picture control system for moving a cursor on a picture within a picture display device, comprising:
a first computer having an input device and connected to the picture within a picture display device;
a second computer having second input devices and connected to the picture within a picture display device;
a first window on the picture within a picture display device for displaying data from the first computer;
a second window on the picture within a picture display device for displaying data from the second computer; and
a picture within a picture control module residing on the first and the second computer that allows the input device to move the cursor within the first window and the second window.

14. The picture within a picture control system of claim 13, wherein the picture within a picture control module on the first computer sends a movement signal from the input device to the first window when the cursor is located in the first window.

15. The picture within a picture control system of claim 13, wherein the picture within a picture control module on the first computer sends a movement signal from the input device to the second window when the cursor is located in the second window.

16. The picture within a picture control system of claim 15, further comprising a network allowing communication between the first computer and the second computer and wherein the movement signal is sent over the network.

17. The picture within a picture control system of claim 13, further including a common memory buffer within the picture within a picture control module.

18. A method of editing data from a first and a second computer systems, the data from the first and second computer systems being displayed on one monitor, the method comprising:
connecting the monitor to the first computer system via a first input connector;
connecting the monitor to the second computer system via a second input connector; and
editing data from the first computer system using an input device connected to the second computer system.
